(19) United States
(12) Patent Application Publication
(10) Pub. No.: US 2010/0093432 A1
(43) Pub. Date: Apr. 15, 2010

(54) A DISPLAY SYSTEM AND METHOD

(76) Inventor: Wah Joo Tan, Kuala Lumpur (MY)

Correspondence Address: GENTING (NSW)PTY LIMITED, 8TH FLOOR, SUSSEX CENTRE,401 SUSSEEX STREET,, SYDNEY, AU

(21) Appl. No.: 12/451,221

(22) PCT Filed: May 1, 2008
(86) PCT No.: PCT/AU2008/000608

§ 371 Date: Nov. 2, 2009

(30) Foreign Application Priority Data
May 4, 2007 (AU) 2007902396

(51) Int. Cl. A63F 13/00

(52) U.S. Cl. 463/31

(57) ABSTRACT

A randomized display system, including i) a transmitter for generating a signal in user input; ii) a receiver for receiving said signal; iii) a processor that, in response to said receiver receiving said signal: a) generates seed data representing one or more randomly generated numbers; b) generates, based on said seed data, sequence data representing a sequence of numbers; c) generates, based on said seed data, graphics data representing one or more graphical display attributes corresponding to each number in said sequence; and iv) a display for displaying, based on said sequence data and said graphics data, said sequence of numbers in accordance with the corresponding said graphical display attributes; and v) where the physical location (on a gaming apparatus, eg. Roulette wheel) of each of the sequence of display is also randomized based on the seed data generated.

### FIELD

The invention relates to a display system and method for gaming, and in particular, but not being limited to, randomised gaming display systems and methods.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

There are many types of games which require an element of physical randomness. An example is the game of Roulette, where the landing position of a ball on the roulette wheel determines the criteria for winning the game. In Roulette, ensuring true randomness of the roulette wheel is a concern for gaming operators since any undetected bias in the roulette wheel picked up by the players may reduce or nullify the slight house advantage (by 2.7% or 1/37 in an unbiased single-zero game, or 5.26% or 2/38 in an unbiased double-zero game).

FIG. 3 is a diagram showing a typical roulette wheel 300, which includes a bowl 302 having a top rim 314 that defines a ball track 304 in the upper portion of the bowl 302. The bowl 302 includes a plurality of ball stops 312 for interrupting the path of the ball when the ball moves inside the bowl 302. The bowl 302 includes a number ring 322 which displays a sequence of numbers on colour background panels (not shown). The bowl 302 also includes a separator ring 318 having a plurality of pockets 316 defined by separators 306, each pocket 316 corresponding to a respective background panel on the number ring 322. The bowl 302 is rotatably mounted onto a turrent 310, which includes an adjusting knob with locking unit 308 that is mounted onto a spindle 320 to enable the bowl 302 to rotate.

The randomness of winning outcomes determined by a roulette wheel could be affected by a number of factors, including any of the following:
i) the level (or tilt) of the wheel and/or the table on which the wheel rests (where tilting is not desirable as it could affect the path of the ball on the wheel);
ii) whether there is unbalanced mass distribution of the rotating components of the wheel;
iii) the angle velocity evenness of the rotating wheel surfaces;
iv) the dimensional evenness of the rotor to which the wheel connects;
v) the dimensional evenness of the pockets and separators/frets;
vi) the material evenness and properties (e.g. where the smoothness or elasticity of the material of the wheel may affect the degree of bounce of the ball) and/or the cleanliness of the wheel's surface making contact with the ball (e.g. where sticky or greasy surfaces on the wheel could affect the travel of the ball);
vii) the surface treatment and finishing of the wheel surface (paint and/or labels);
viii) the evenness of the shape and/or position of ball-stops; and
ix) the logical order of numbers printed on the number ring.

It is desired to address one or more of the above, or to at least provide a useful alternative.

### SUMMARY

What has been proposed is a digital approach to generating randomised indicia on a roulette wheel instead of relying on conventional mechanical/physical approaches to ensure randomness in the results determined using a physical roulette wheel.

According to the present invention, there is provided a randomised display system, including:
i) a transmitter for generating a signal in response to user input;
ii) a receiver for receiving said signal;
iii) a processor that, in response to said receiver receiving said signal:
   a) generates seed data representing one or more randomly generated numbers;
   b) generates, based on said seed data, sequence data representing a sequence of numbers;
   c) generates, based on said seed data, graphics data representing one or more graphical display attributes corresponding to each number in said sequence; and
iv) a display for displaying, based on said sequence data and said graphics data, said sequence of numbers in accordance with the corresponding said graphical display attributes.

The present invention also provides a randomised display method, including:
i) generating a signal in response to user input;
ii) receiving said signal;
iii) generating, in response to receiving said signal, seed data representing one or more randomly generated numbers;
iv) generating, based on said seed data, sequence data representing a sequence of numbers;
v) generating, based on said seed data, graphics data representing one or more graphical display attributes corresponding to each number in said sequence; and
vi) generating, based on said sequence data and said graphics data, a display including said sequence of numbers in accordance with the corresponding said graphical display attributes.

The present invention also provides a gaming apparatus including a randomised display system, or using a display method, as described above.

### BRIEF DESCRIPTION OF THE DRAWINGS

Preferred embodiments of the present invention are herein described, by way of example only, with reference to the accompanying drawings wherein:

FIG. 1 is a block drawing showing the components of the display system;

FIG. 2 is a flow diagram showing the steps performed by the display system;

FIG. 3 is a diagram of a roulette wheel; and

FIG. 4 is a diagram of a modified roulette wheel for the display system.

### DETAILED DESCRIPTION OF THE PREFERRED EMBODIMENTS

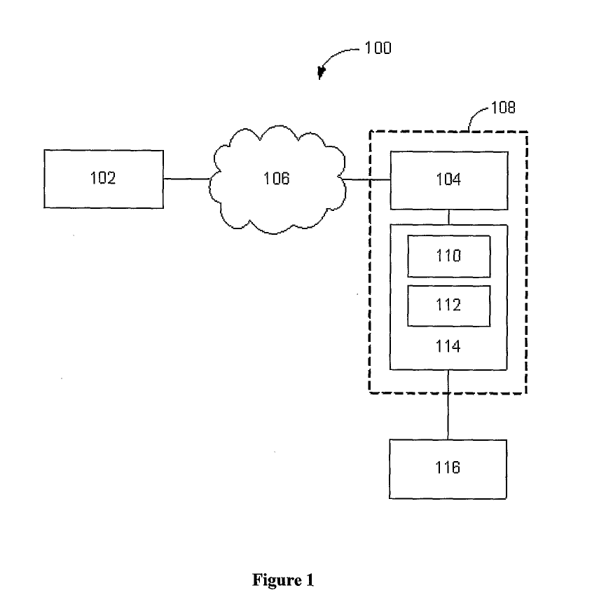

The display system 100, as shown in FIG. 1, includes a transmitter 102 that communicates with a controller 108 via a communications network 106 (such as the Internet, a local area network, a wireless Bluetooth or 802.11a/b/g/n network, or a wired connection between the transmitter 102 and controller 108). The transmitter 102 generates a signal in response to any form of user input or action. For example, the signal could be a coded or encrypted signal that is generated in response to a user pressing a button on the transmitter 102. The controller 108 includes a receiver 104 for receiving the signal from the transmitter 102, and a processor 114 for performing one or more actions in response to receiving the signal.

The transmitter 102 and controller 108 may use one or more of the following mechanisms to protect communications between the transmitter 102 and controller 108:
i) the transmitter 102 and controller 108 may each include an authentication module (not shown in FIG. 1) that prompts the user to provide authentication or identification details (e.g. a username and password provided during a user log-in process). The authentication module verifies the user-provided authentication/identification details to determine whether that user is permitted to control or operate the transmitter 102 or controller 108. For example, the authentication module queries a database using the user-provided authentication/identification details, and allows the transmitter 102 to generate and send signals to the controller 108 (or the controller 108 to respond to signals from the transmitter 102) only if those details match authentication/identification details stored in the database;
ii) each transmitter 102 may be associated with a unique device identifier, and the device identifiers for one or more different transmitters 102 are preconfigured (or stored) into the controller 108 for device authentication. Each transmitter 102 may generate a signal that includes at least one device identifier, or a signal that is encrypted based on the device identifier of a particular controller 108 (e.g. using private key encryption techniques). The controller 108 may only respond to signals including (or encrypted using) a device identifier associated with that controller 108;
iii) the signal transmitted by the transmitter 102 is encrypted at the application level (e.g. by an application for controlling the operation of one or more controllers 108) that includes (or is encrypted based on) a digital signature or certificate. For example, the digital signature/certificate may be unique to each transmitter 102 to ensure the authenticity of the signals from potential intrusion into the communication channel from other hostile devices. Alternatively, the transmitter 102 may use a single digital signature/certificate in communications with multiple controller devices 108;
iv) for the same objective of preventing fraud, as in item (iii), the signal transmitted by each transmitter 102 may be associated with a unique serial number to prevent ‘play back’ (i.e. recording for later retransmission) of any recorded historical signals previously generated by a transmitter 102; and
v) a transmitter 102 may receive feedback from a controller 108 for every change that takes place on the display unit 116 controlled by the controller 108. This may involve the controller 108 generating feedback data representing the location/position of the change (e.g. for a specific display region of the display unit 116) and the type of change (e.g. changes in values in the numeric sequence or graphical features such as colour or symbols for that display region), in comparison to the data previously generated by the controller 108 for display on the display unit 116. This enables a user of the display system 100 (e.g. a human operator at a gaming table of a casino) to monitor changes to the display unit 116 and detect unsolicited changes to the results displayed by the display unit 116 that may be caused by a successful hack into the controller 108.

The above security measures aim to prevent eavesdropping and unauthorised manipulation or interference of the signal sent from the transmitter 102 to the receiver 104 in a controller 108.

The random seed generator module 110 and processing module 112 controls the processor 114 to generate display data for a display unit 116. The random seed generator module 110 and processing module 112 are provided by computer program code in languages such as C, C++ or C# and the .NET platform or other suitable programming languages, which are executed on a processor 114 of a standard personal computer (such as that provided by IBM Corporation <http://www.ibm.com> or Hewlett Packard <http://www.hp.com>) running a standard operating system, such as Windows™ or Unix. Those skilled in the art will also appreciate that the processes performed by the modules 110 and 112 (or the processor 114 under the control of modules 110 and 112) can also be executed at least in part by dedicated hardware circuits, eg Application Specific Integrated Circuits (ASICs) or Field-Programmable Gate Arrays (FPGAs).

When the receiver 104 receives the signal from the transmitter 102, the processor 114 responds by generating, under the control of the random seed generator module 110, seed data representing a sequence of one or more randomly generated numbers. For example, the random seed generator module 110 may generate each number represented by the seed data independently of the other numbers in the same sequence.

The processing module 112 then generates, based on the seed data, sequence data representing a sequence of numbers for display using the display device 116. The numbers represented by the sequence data may be selected from a predetermined range (preferably integers from 0 to 36, and optionally including other predefined integers such as “00” as an integer in the sequence).

The sequence data can be generated in several ways. According to one method, the processor 114 stores (e.g. in memory included in, or external to, the processor 114 such as Random-Access Memory (RAM), Read-Only Memory (ROM) or physical storage media such as a hard disk) one or more predetermined sequences of numbers. The processing module 112 controls the processor 114 to select one of the predetermined numeric sequences based on the value of a first number represented by the seed data. For example, the first random number represented by the seed data is expected to fall within a predetermined range (e.g. between 0 and 1), where the range is divided into one or more brackets of values each corresponding to a particular predefined sequence of numbers. For example, a first bracket may be defined by numbers falling between and including 0 and 0.3. A second bracket may be defined by numbers greater than 0.3 and up to and including 0.6. A third bracket may be defined by numbers greater than 0.6 and up to and including 1.0. If the value of the random number represented by the seed data falls within a particular bracket, the corresponding sequence of numbers is selected by the processor 114. The ranges of values for each bracket are predefined. Alternatively, each of the numbers of in the sequence may be generated based on a different random number represented by the seed data based on a sequence generation algorithm.

In yet another embodiment, more than one random seed number may be generated (as represented by the seed data). For example, the seed data represents at least one random seed number that is used for determining the numeric sequence to be displayed, and at least another random seed number to be used for determining an offset position for the commencement of the selected numeric sequence.

The processing module 112 controls the processor 114 to generate, based on a second number represented by the seed data (or alternatively based on the first number represented by the seed number), offset data representing an offset position relative to a fixed or predefined reference position on the display device 116 (e.g. on the roulette wheel) for the commencement of a selected sequence of numbers.

The processing module 112 controls the processor 114 to generate also, based on the seed data, graphics data representing one or more graphical display attributes corresponding to each number represented by the sequence data.

Graphics data may include colour pattern data representing the colours corresponding to the sequence, where each number in the sequence corresponds to one of several predetermined colours. The colour pattern data may include colour data defining one or more colours for displaying the corresponding number on the display unit 116, and one or more colours of the background on which the corresponding number is displayed by the display unit 116. For example, the colour pattern data may associate the number “0” or “00” in the sequence with the colour green. The remaining colours may be associated with the colours red and black in alternating sequence. Other colours can be used, and association of colours with the numbers in the sequence can be determined based on preferred (i.e. predetermined colour association with each number) design pattern of the game.

Furthermore, graphics data may include image data representing one or more different graphical images corresponding to one or more different numbers in the sequence. The graphical images may include representations of different animals (e.g. fishes, birds or other animals), different precious stones or other types of symbols. The graphical images may be associated with particular types of numbers (e.g. numbers within a particular range, or odd or even numbers).

The processing module 112 controls the processor 114 to generate, based on the sequence data, colour pattern data and/or graphics data, display data for displaying the sequence of numbers with the corresponding colours and/or graphical images on the display unit 116.

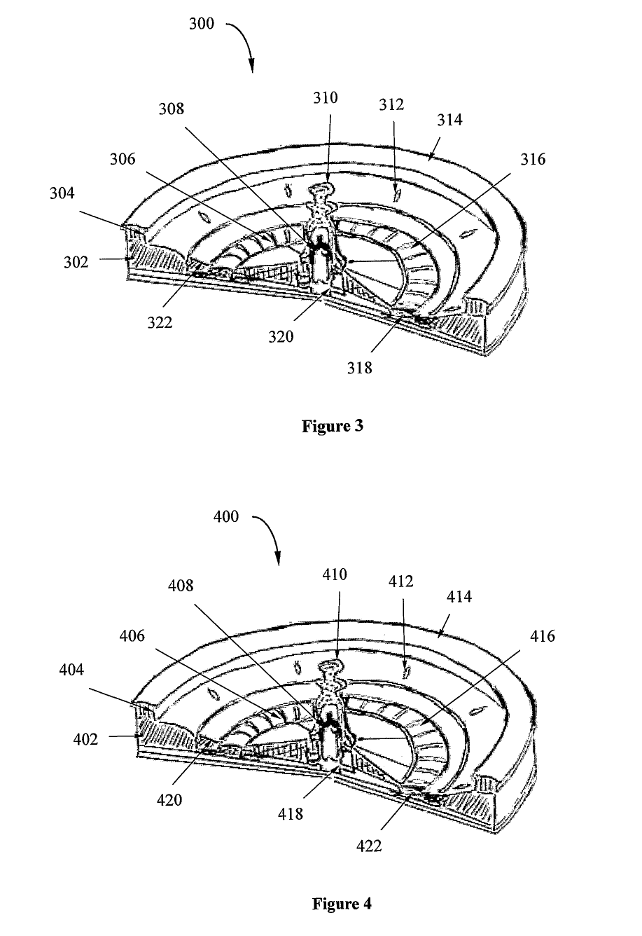

The display unit 116 may be incorporated into a gaming apparatus, such as a modified version of the roulette wheel 400 as shown in FIG. 4. Similar to the wheel 300 as shown in FIG. 3, the modified roulette wheel 400 includes a bowl 402, ball track 404, separator 406, adjusting knob with locking unit 408, turrent 410, one or more ball stops 412, top rim 414, one or more pockets 416 and a spindle 418. However, the modified roulette wheel 400 further incorporates a display unit 116 (as described above) that includes a plurality of primary display regions corresponding to the plurality of electronic displays on the number ring for displaying numbers, and preferably also a plurality of secondary display regions, where each of the primary and secondary display regions correspond to one of a plurality of electronic displays on the separator ring for displaying different colours. The roulette wheel may be spun manually by a dealer or mechanically as in the case of using a motorised wheel.

The display unit 116 includes a first display (e.g. a Liquid Crystal Display (LCD) or Light-Emitting Diode (LED) type display including a plurality of primary display regions. For example, each primary display region corresponds to a cell for displaying a number in the number ring 322 as shown in FIG. 3. Each primary display region displays, based on the display data, a number in the sequence (represented by the sequence data), and each primary display region may display a particular background colour (defined by the colour pattern data) corresponding to the number shown in the primary display region. For example, a primary display region may display a number in the sequence represented by the sequence data on a background with colour as defined by the colour pattern data for a position in the sequence.

The display unit 116 may include a second display (e.g. of similar type as the first display) including a plurality of secondary display regions. For example, each secondary display region corresponds to a pocket 316 as shown in FIG. 3. Each secondary display region corresponds to a primary display region and displays, based on the display data, a particular background colour (defined by the colour pattern data) corresponding to the number shown in the corresponding primary display region.

The secondary display regions may be configured to display, based on the display data, one or more graphical images as defined by the graphics data generated by the processor 114. Alternatively, the display unit 116 may include a third display (eg of similar type as the first display) including a plurality of tertiary display regions. Each tertiary display region corresponds to a primary display region and displays, based on the display data, a particular graphical images associated with the number shown in the corresponding primary display region.

Alternatively, each of the primary display regions of the display unit 116 could be configured to perform the functions of one of the secondary display regions and/or one of the tertiary display regions respectively of the display unit 116 as described above. For example, a primary display region, and either a secondary display region and/or a tertiary display region may be part of a single cell for displaying number, colour and/or graphical information corresponding to a particular number in the sequence as defined by the sequence data.

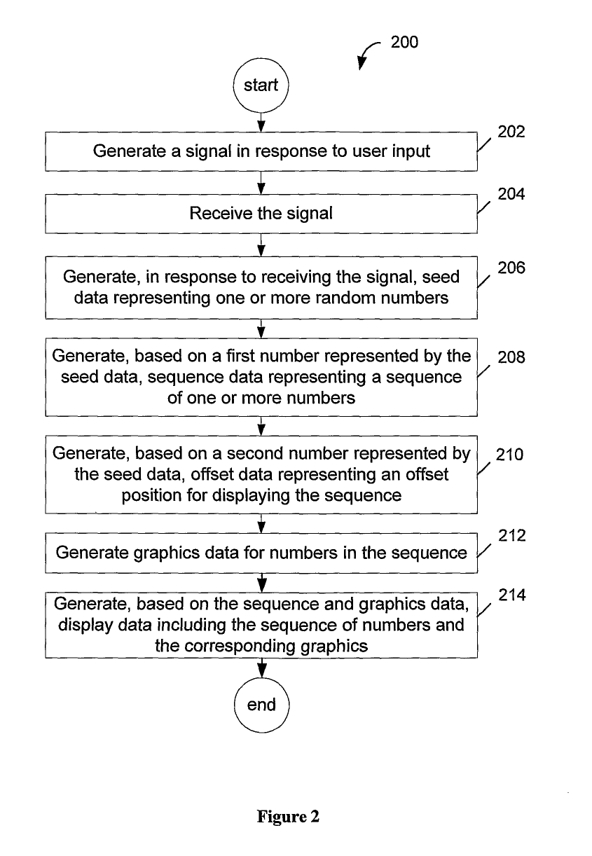

FIG. 2 shows a control process 200 performed by the display system 100 (including the steps performed by the processor 114 under the control of the random seed generator module 110 and processing module 112). Control process 200 beings at step 202 where the transmitter 102 generates a signal in response to user input. At step 204, the receiver 104 receives the signal. At step 206, the processor 114 responds to the signal received by the receiver 104 by generating seed data representing one or more randomly generated numbers. At step 208, the processor 114 selects (from a list of predetermined sequences) and generates, based on a first number represented by the seed data, predetermined numeric sequence data representing a sequence of numbers (as described above). At step 210, the processor 114 generates, based on a second number represented by the seed data (or alternatively the first number from the seed data as described above), offset data representing an offset position relative to a fixed reference point on the roulette wheel for commencement of numeric sequence (as described above). At step 212, the processor 114 generates, based on the numeric sequence data and offset data, graphics data including colour pattern data and image data as described above. At step 214, the processor 114 generates, based on the sequence and the graphics data for that sequence, display data representing a randomised display including the sequence of numbers and associated colours and graphical images corresponding to those numbers.

It is possible to control the timing at which relevant information is generated for display on the display unit 116. For example, in some jurisdictions (e.g. the United Kingdom), a roulette wheel which incorporates one or more random seed generator may be classified as an electronic gaming machine. However, this may be mitigated if (and a preferred embodiment of the invention provides that) the information for display on the randomised display unit 116 is generated (e.g. in response to user input) whilst the wheel 400 is rotating before or after the ball has been spun, but before “no more bets” is announced. This may be advantageous because a spinning wheel with randomly generated numbers (or other indicia) will add more complexity to players trying to spot any bias of wheel segments (e.g. on a roulette wheel 400) even though they can place their bets after the display patterns are fixed by the random generator(s). In this way, technically the information displayed on the roulette displays units 116 are not generated randomly after the bets are placed, but rather, before the bets are placed or finalised.

The word ‘comprising’ and forms of the word ‘comprising’ as used in this description does not limit the invention claimed to exclude any variants or additions.

Modifications and improvements to the invention will be readily apparent to those skilled in the art. Such modifications and improvements are intended to be within the scope of this invention.

1. A randomised display system, including:
i) a transmitter for generating a signal in response to user input;
ii) a receiver for receiving said signal;
iii) a processor that, in response to said receiver receiving said signal:
a) generates seed data representing one or more randomly generated numbers;
b) generates, based on said seed data, sequence data representing a sequence of numbers;
c) generates, based on said seed data, graphics data representing one or more graphical display attributes corresponding to each number in said sequence; and
iv) a display for displaying, based on said sequence data and said graphics data, said sequence of numbers in accordance with the corresponding said graphical display attributes.

2. A system as claimed in claim 1, wherein said sequence represents a selected one of several predetermined numeric sequences.

3. A system as claimed in claim 1, wherein said display includes:
one or more plurality of primary display regions, each said primary display region for displaying, based on said sequence data and said graphics data, a respective number in said sequence and having an associated background colour corresponding to the number for that primary display region.

4. A system as claimed in claim 3, wherein generating said sequence data includes:
generating, based on a first number represented by said seed data, offset data representing one of said primary display regions relative to a preselected one of said primary display regions serving as a reference; and
generating, based on a second number represented by said seed data, said sequence of numbers for display in said primary display regions in order starting from the primary display region represented by said offset data.

5. A system as claimed in claim 3, wherein said display includes:
one or more secondary display regions, each said secondary display region for displaying a coloured background corresponding to a particular said primary display region.

6. A system as claimed in claim 5, wherein in response to said receiver receiving said signal, said processor:
generates, based on said sequence and said offset data, said graphics data representing one or more different graphical images corresponding to one or more different numbers in said sequence.

7. A system as claimed in claim 6, wherein said graphics data controls one or more of said secondary display regions to display one or more graphical images respectively.

8. A system as claimed in claim 6, wherein said display includes:
one or more tertiary display regions corresponding to each of said primary display regions, wherein said graphics data controls one or more of said tertiary display regions to display one or more graphical images respectively.

9. A system as claimed in claim 1, wherein, for each said number in said sequence, said graphics data includes any of the following:
colour pattern data including data representing a predetermined colour of the background on which said number is displayed; and
image data representing a graphical image or symbol.

10. A randomised display method, including:
i) generating a signal in response to user input;
ii) receiving said signal;
iii) generating, in response to receiving said signal, seed data representing one or more randomly generated numbers;
iv) generating, based on said seed data, sequence data representing a sequence of numbers;
v) generating, based on said seed data, graphics data representing one or more graphical display attributes corresponding to each number in said sequence; and
vi) generating, based on said sequence data and said graphics data, a display including said sequence of numbers in accordance with the corresponding said graphical display attributes.

11. A method as claimed in claim 9, wherein said sequence represents a selected one of several predetermined numeric sequences.

12. A method as claimed in claim 10, wherein said generating a display includes:
generating for display in one or more primary display regions, based on said sequence data and said colour pattern data, a respective number in said sequence, and having a background colour corresponding to the number for that primary display region.

13. A method as claimed in claim 10, wherein generating said sequence data includes:
generating, based on a first number represented by said seed data, offset data representing one of said display regions relative to a preselected one of said display regions serving as a reference; and
generating, based on a second number represented by said seed data, said sequence of numbers for display in said display regions in order starting from said display region represented by said offset data.

14. A method as claimed in claim 10, wherein, for each said number in said sequence, said graphics data includes at least one of:
colour pattern data including data representing a predetermined colour of the background on which a said number is displayed; and
image data representing a graphical image or symbol.

15. A method as claimed in claim 14, wherein said colour pattern data associates the first number in said sequence with a first colour, and associates the remaining numbers in said sequence with a second colour and third colour alternately.

16. A method as claimed in claim 10, wherein said generating a display includes:
generating for display in one or more secondary display regions, each said secondary display region having a background colour corresponding to a particular said primary display region.

17. A method as claimed in claim 16, wherein said graphics data representing one or more different graphical images corresponding to one or more different numbers in said sequence.

18. A method as claimed in claim 17, wherein said graphics data controls one or more of said secondary display regions to display one or more graphical images respectively.

19. A method as claimed in claim 18, wherein said generating a display includes:
generating for display in one or more tertiary display regions corresponding to each of said primary display regions, wherein said graphics data controls one or more of said tertiary display regions to display one or more a graphical images respectively.

20. A method as claimed in claim 10, wherein said step (i) is performed before the time at which no further bets are accepted in respect of a game involving said method.

21. A gaming apparatus including a randomised display system as claimed in claim 1.

22. A gaming apparatus as claimed in claim 21, which when set in motion for a game, said processor performs said steps (a), (b) and (c) before the time at which no further bets are accepted in respect of said game.

23. A gaming apparatus as claimed in claim 21, which when set in motion for a game, said processor performs said steps (a), (b) and (c) at the same time or after the time at which no further bets are announced in respect of said game.

24. A method as claimed in claim 9, wherein said sequence may represent a simple sequence as one of the variations under claims 1 & 2 (in whatever form—such as a simple consecutive sequence, 1,2,3,4,5, etc. . . . ) which encourages certain wagering behaviour such as sector betting (on the roulette wheel), due to the perceived simplicity of sequence supporting such betting behaviour; whilst the underlying randomness of the wheel is not compromised due to the randomness of the physical location on the gaming apparatus (the roulette wheel) on which each of the specific numbers in the sequence is displayed.

25. A method as claimed in claim 9, wherein the said sequence may be of other variations under claims 1 & 2 which encourages also other betting behaviour such as multi-layer betting such as, besides betting on the number, the customer may also bet on the colour of the number or certain patterns simultaneously.
